(19) United States
(12) Patent Application Publication
(10) Pub. No.: US 2020/0009888 A1
(43) Pub. Date: Jan. 9, 2020

(54) AIR SUCTION DEVICE CAPABLE OF RESTRICTING LEAKAGE OF LIQUID FROM AIR DUCT, INKJET RECORDING APPARATUS

(71) Applicant: KYOCERA Document Solutions Inc., Osaka (JP)

(72) Inventor: Hironori Daigo, Osaka (JP)

(21) Appl. No.: 16/452,983

(22) Filed: Jun. 26, 2019

(30) Foreign Application Priority Data
Jul. 3, 2018 (JP) 2018-126837

(51) Int. Cl. B41J 29/377; F24F 7/06

(52) U.S. Cl. CPC B41J 29/377; F24F 7/065

(57) ABSTRACT

An air suction device includes an air duct and a fan. The air duct includes a plurality of guide members and extends from an ejection space in which a liquid is ejected, to an air discharge port. The fan generates an air flow that moves inside the air duct toward the air discharge port. The air duct includes a wind passage and a pair of wall portions. The wind passage extends upward from a bottom surface that is formed from the plurality of guide members. The wind passage guides the air flow. The pair of wall portions are formed on the bottom surface to face each other across a joint connecting the plurality of guide members.

### INCORPORATION BY REFERENCE

This application is based upon and claims the benefit of priority from the corresponding Japanese Patent Application No. 2018-126837 filed on Jul. 3, 2018, the entire contents of which are incorporated herein by reference.

### BACKGROUND

The present disclosure relates to an air suction device, and an inkjet recording apparatus that includes an air suction device.

An inkjet recording apparatus for recording an image by an inkjet method includes a recording head and a sheet supporting portion. The recording head ejects ink toward a sheet. The sheet supporting portion supports the sheet at an ink ejection position where the ink is ejected from the recording head.

In some inkjet recording apparatuses of this type, the air is sucked from a rear side of a surface of the sheet supporting portion on which a sheet is supported. For example, there is known an inkjet recording apparatus that includes an air duct and a fan, wherein the air duct is communicated from an air suction port formed in the sheet supporting surface to an air discharge port, and the fan generates an air flow that moves inside the air duct from the air suction port to the air discharge port.

### SUMMARY

An air suction device according to an aspect of the present disclosure includes an air duct and a fan. The air duct includes a plurality of guide members and extends from an ejection space in which liquid droplets are ejected, to an air discharge port. The fan generates an air flow that moves inside the air duct toward the air discharge port. The air duct includes a wind passage and a pair of wall portions. The wind passage extends upward from a bottom surface that is formed from the plurality of guide members. The wind passage guides the air flow. The pair of wall portions are formed on the bottom surface to face each other across a joint connecting the plurality of guide members.

An inkjet recording apparatus according to another aspect of the present disclosure includes the air suction device, and the liquid droplets are ink droplets used to record an image on a recording medium.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an inkjet recording apparatus according to an embodiment of the present disclosure.

FIG. 2 is a diagram showing a configuration of a recording portion included in the inkjet recording apparatus according to the embodiment of the present disclosure.

FIG. 3 is a diagram showing a configuration of a surface of a conveyance belt included in the inkjet recording apparatus according to the embodiment of the present disclosure.

FIG. 4 is a diagram showing a configuration of an air suction portion included in the inkjet recording apparatus according to the embodiment of the present disclosure.

FIG. 5 is a diagram showing a configuration of the air suction portion included in the inkjet recording apparatus according to the embodiment of the present disclosure.

FIG. 6 is a diagram showing a configuration of an air duct included in the inkjet recording apparatus according to the embodiment of the present disclosure.

FIG. 7 is a diagram showing a configuration of the air duct included in the inkjet recording apparatus according to the embodiment of the present disclosure.

FIG. 8 is a diagram showing a configuration of the air duct included in the inkjet recording apparatus according to the embodiment of the present disclosure.

FIG. 9 is a diagram showing a modification of the air duct included in the inkjet recording apparatus according to the embodiment of the present disclosure.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Outline Configuration of Inkjet Recording Apparatus 10]

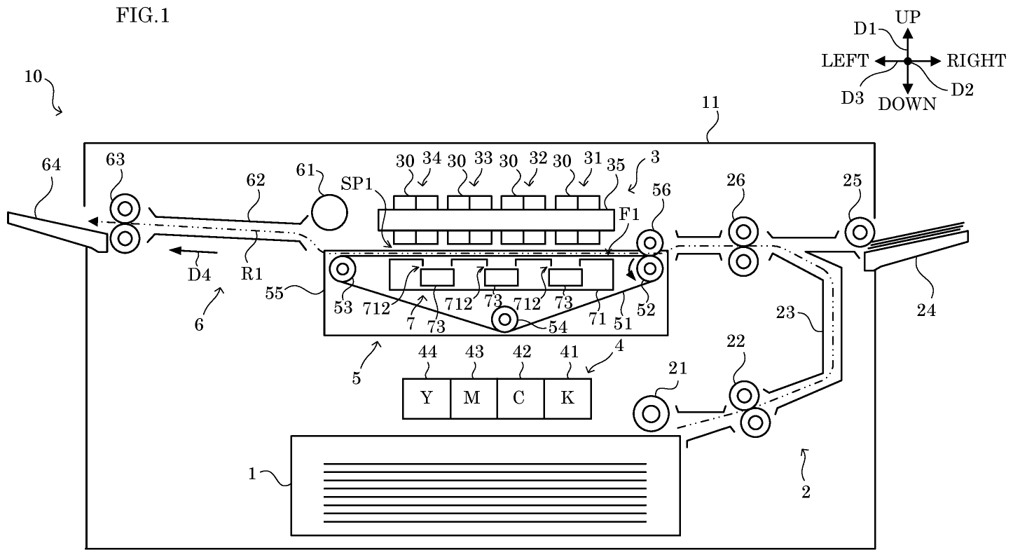

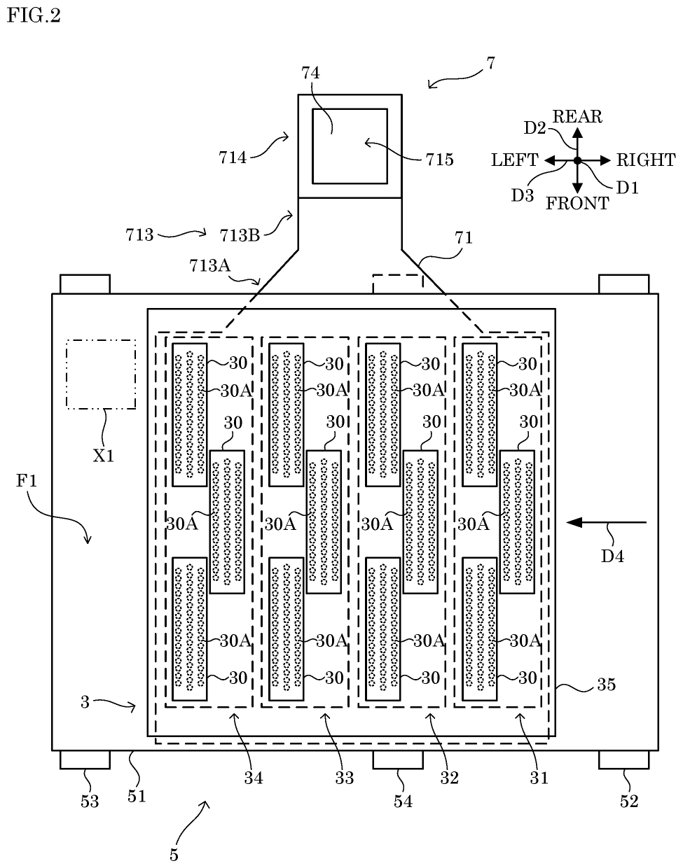

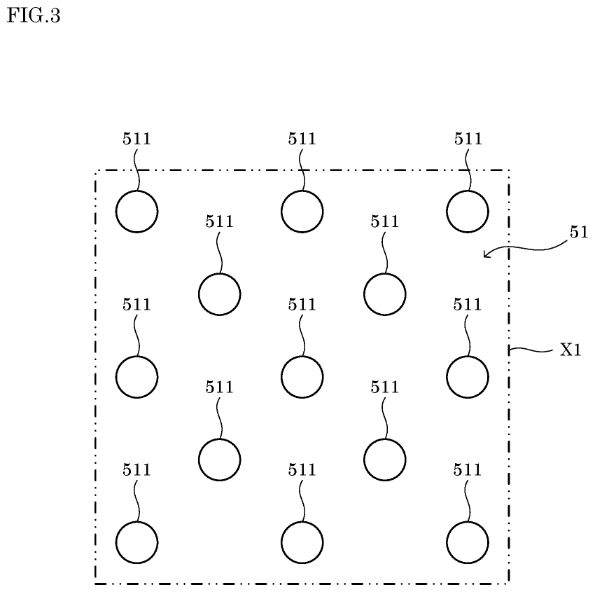

First, a description is given of an outline configuration of an inkjet recording apparatus 10 according to an embodiment of the present disclosure, with reference to FIG. 1 to FIG. 3. Here, FIG. 1 is a schematic cross-sectional diagram showing a configuration of the inkjet recording apparatus 10. FIG. 2 is a plan diagram showing a configuration of a recording portion 3. FIG. 3 is an enlargement diagram of a region X1 which is shown in FIG. 2 as enclosed by a two-dot chain line. It is noted that in FIG. 1, a sheet conveyance path R1 provided inside a housing 11 of the inkjet recording apparatus 10 is represented by a two-dot chain line.

For the sake of explanation, an up-down direction D1 is defined as a vertical direction in a state where the inkjet recording apparatus 10 is installed usably (the state shown in FIG. 1). In addition, a front-rear direction D2 is defined on the supposition that a side of the inkjet recording apparatus 10 on the front side of the plane of FIG. 1 is a front side (front). Furthermore, a left-right direction D3 is defined based on the inkjet recording apparatus 10 in the installation state viewed from the front side.

The inkjet recording apparatus 10 is a printer that can record an image by an inkjet method. It is noted that the inkjet recording apparatus 10 may be a facsimile apparatus, a copier, or a multifunction peripheral.

As shown in FIG. 1, the inkjet recording apparatus 10 includes a sheet feed cassette 1, a sheet feed portion 2, a recording portion 3, an ink container portion 4, a conveyance unit 5, a sheet discharge portion 6, and an air suction portion 7.

The sheet feed cassette 1 stores sheets (an example of a recording medium of the present disclosure) on which images are to be recorded in the inkjet recording apparatus 10. For example, the sheets stored in the sheet feed cassette 1 are sheet-like materials such as sheets of paper, sheets of coated paper, postcards, envelopes, and OHP sheets.

In the inkjet recording apparatus 10, the sheets stored in the sheet feed cassette 1 are conveyed one by one along the conveyance path R1 that passes an ink ejection space SP1 where ink is ejected by the recording portion 3.

The sheet feed portion 2 supplies sheets stored in the sheet feed cassette 1 one by one to the ink ejection space SP1. As shown in FIG. 1, the sheet feed portion 2 includes a pickup roller 21, a conveyance roller 22, a conveyance path 23, a manual feed tray 24, a sheet feed roller 25, and a registration roller 26.

The pickup roller 21 picks up, one by one, the sheets from the sheet feed cassette 1. The conveyance roller 22 conveys the sheet picked up by the pickup roller 21 to the registration roller 26. The conveyance path 23 is a moving passage of sheets from the sheet feed cassette 1 and the manual feed tray 24 to the ink ejection space SP1. The manual feed tray 24 and the sheet feed roller 25 are used to supply sheets from outside. Each time a predetermined conveyance timing comes, the registration roller 26 conveys a sheet to the ink ejection space SP1. For example, the conveyance timing is when a predetermined time period has elapsed from a time when a front end of the sheet was detected by a sheet sensor (not shown) that is provided on an upstream side of the registration roller 26 in a sheet conveyance direction D4 in the conveyance path R1.

The recording portion 3 records an image on a sheet by ejecting ink (an example of liquid droplets of the present disclosure) toward the sheet that is supported by a conveyance belt 51 of the conveyance unit 5. As shown in FIG. 1, the recording portion 3 is provided above the conveyance unit 5. A space between the recording portion 3 and the conveyance belt 51 of the conveyance unit 5 is the ink ejection space SP1.

The recording portion 3 includes line heads 31, 32, 33, and 34 and a head frame 35 supporting the line heads, the line heads 31, 32, 33, and 34 respectively corresponding to colors black, cyan, magenta, and yellow. The head frame 35 is supported by the housing 11 of the inkjet recording apparatus 10. It is noted that the number of the line heads included in the recording portion 3 is not limited to 4 (four), but may be any one of 1 (one) to 3 (three), or 5 (five) or more.

The line heads 31 to 34 are so-called line-head-type recording heads. That is, the inkjet recording apparatus 10 is a so-called line-head-type printer. As shown in FIG. 2, the line heads 31 to 34 are elongated in the front-rear direction D2. Specifically, each of the line heads 31 to 34 has a length in the front-rear direction D2 that corresponds to the width of a sheet of the maximum size among a plurality of sizes of sheets that can be stored in the sheet feed cassette 1. The line heads 31 to 34 are fixed to the head frame 35 at regular intervals along the sheet conveyance direction D4.

As shown in FIG. 2, each of the line heads 31 to 34 includes a plurality of recording heads 30. The recording heads 30 eject ink toward a sheet supported by the conveyance belt 51. Specifically, a lot of nozzles 30A for ejecting ink are provided on a facing surface of each of the recording heads 30, each of the nozzles 30A having an opening, the facing surface facing the conveyance belt 51. In addition, each of the recording heads 30 includes pressurizing chambers (not shown) and piezoelectric elements (not shown), the pressurizing chambers respectively corresponding to the nozzles 30A, the piezoelectric elements respectively corresponding to the pressurizing chambers. Upon application of a predetermined driving voltage, each of the piezoelectric elements pressurizes ink stored in the pressurizing chamber and causes ink to be ejected from the nozzle 30A. Driving of the piezoelectric elements is controlled based on image data that is used to record an image.

In the present embodiment, in the line head 31, three recording heads 30 are arranged in zigzag along the front-rear direction D2. In addition, in each of the line heads 32 to 34, as in the line head 31, three recording heads 30 are arranged in zigzag along the front-rear direction D2. It is noted that FIG. 2 shows an arrangement state of the recording heads 30 in the recording portion 3 viewed from the upper side of FIG. 1.

As shown in FIG. 1, the ink container portion 4 includes ink containers 41, 42, 43, and 44 that respectively store black, cyan, magenta, and yellow ink. The ink containers 41 to 44 are connected to the line heads 31 to 34 of the corresponding colors, via ink supply portions (not shown), respectively.

The conveyance unit 5 supports a sheet in the ink ejection space SP1, and conveys the sheet to the sheet discharge portion 6. As shown in FIG. 1, the conveyance unit 5 includes the conveyance belt 51, stretching rollers 52 to 54 over which the conveyance belt 51 is stretched, and a conveyance frame 55 that supports these members.

The stretching rollers 52 and 53 are arranged separately from each other along the left-right direction D3 on both sides of the ink ejection space SP1. The stretching roller 54 is provided at a position between and lower than the stretching rollers 52 and 53. The conveyance belt 51 stretched over the stretching rollers 52 to 54 forms a sheet support surface F1 that supports a sheet in a state of facing the line heads 31 to 34. It is noted that the interval between the sheet support surface F1 and the recording heads 30 is adjusted so that during an image formation, the interval between the sheet surface and the recording heads 30 is, for example, 1 (one) mm.

A lot of through holes 511 (see FIG. 3) are formed in the surface of the conveyance belt 51. The through holes 511 are regularly arranged over the whole region of the surface of the conveyance belt 51.

The stretching roller 52 is rotationally driven to rotate, by a rotational driving force supplied from a motor (not shown). This causes the conveyance belt 51 to move in a direction that allows the sheet to be conveyed in the conveyance direction D4. As the moving conveyance belt 51 moves in this way, the sheet supported by the sheet support surface F1 is conveyed to the sheet discharge portion 6. It is noted that a pressure roller 56 is provided at a position that faces the stretching roller 52 so that the sheet is pressed against the conveyance belt 51 and conveyed thereon.

The sheet discharge portion 6 is configured to discharge the sheet, with an image recorded thereon by the recording portion 3, to outside. As shown in FIG. 1, the sheet discharge portion 6 includes a drying device 61, a conveyance path 62, a sheet discharge roller 63, and a sheet discharge tray 64. The drying device 61 dries the ink that has adhered to the sheet, by, for example, blowing the air to the sheet. The conveyance path 62 is a moving passage of the sheet from the ink ejection space SP1 to the sheet discharge tray 64. The sheet discharge roller 63 discharges the sheet to the sheet discharge tray 64.

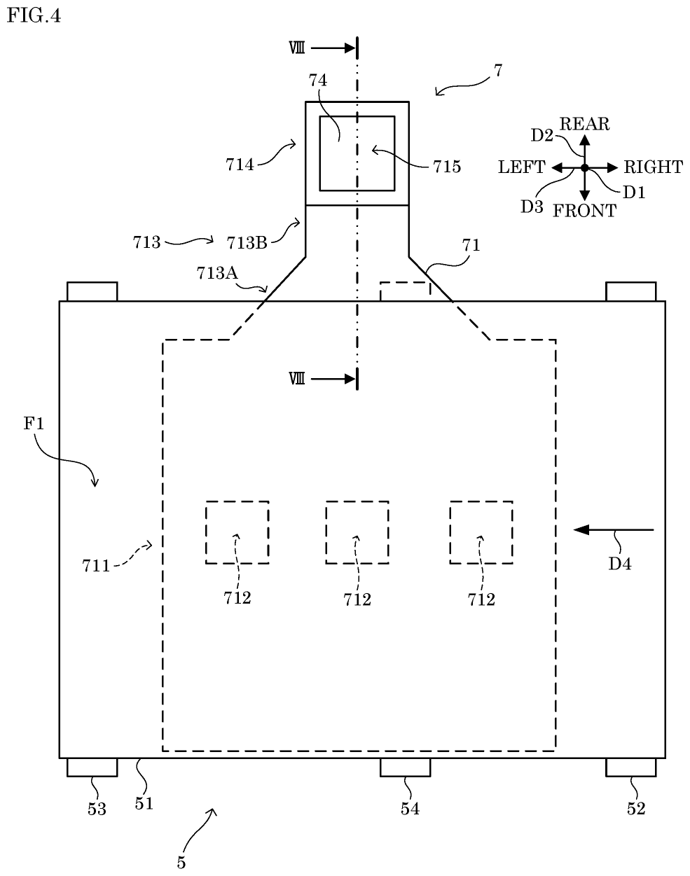

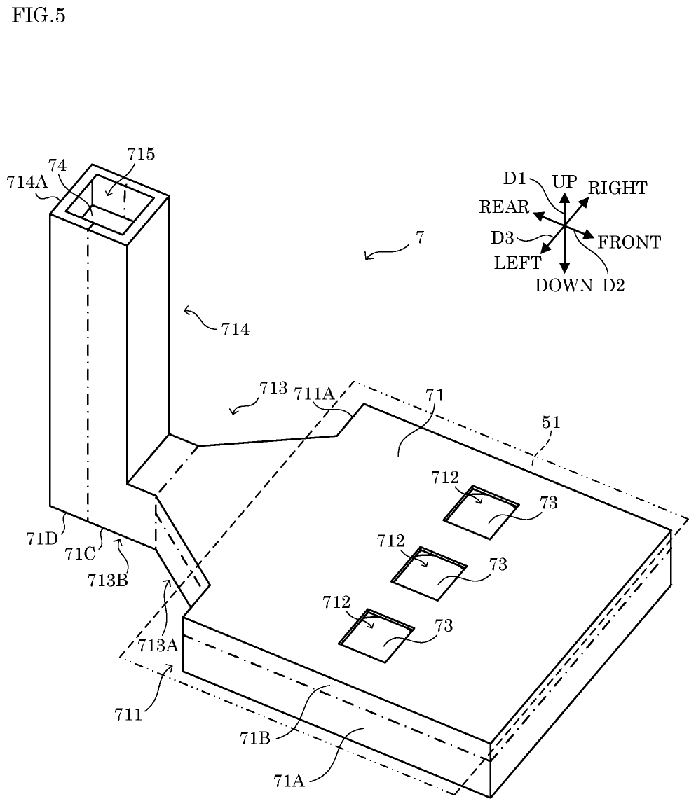

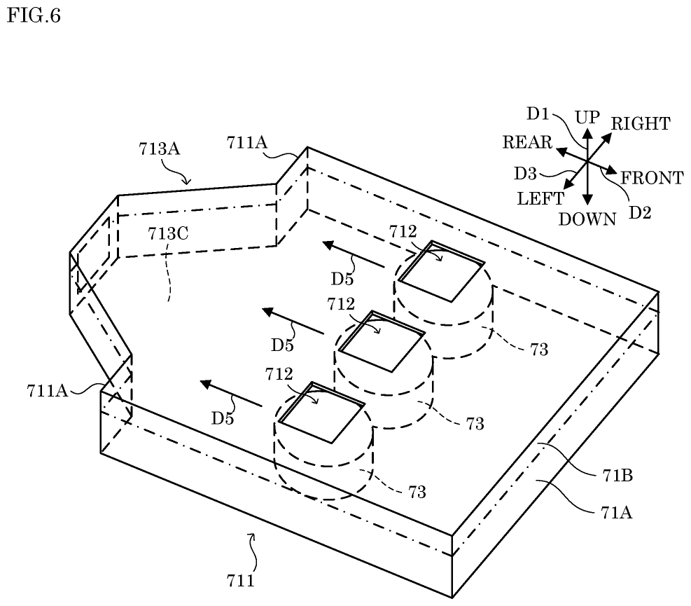

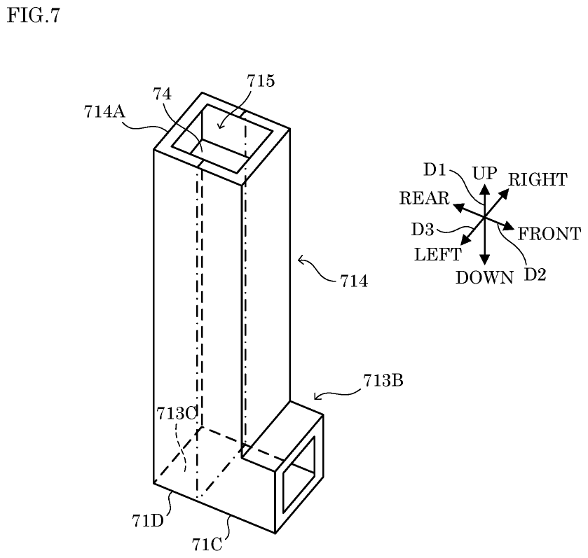

Next, the air suction portion 7 is described with reference to FIG. 1 and FIG. 4 to FIG. 7. FIG. 4 is a plan diagram showing a configuration of the conveyance unit 5 and the air suction portion 7. FIG. 5 is a perspective diagram showing a configuration of the air suction portion 7. FIG. 6 is a perspective diagram showing a part of an air duct 71 that is composed of a guide member 71A and a guide member 71B. FIG. 7 is a perspective diagram showing a part of the air duct 71 that is composed of a guide member 71C and a guide member 71D. It is noted that in FIG. 5, connection portions connecting the guide members of the air duct 71 are represented by one-dot chain lines. In FIG. 6, a connection portion connecting the guide member 71A and the guide member 71B is represented by a one-dot chain line. In FIG. 7, a connection portion connecting the guide member 71C and the guide member 71D is represented by a one-dot chain line.

The air suction portion 7 is configured to suck the air from a rear side of the sheet support surface F1 (see FIG. 1) so that the sheet supported by the sheet support surface F1 is attracted by the sheet support surface F1. The air suction portion 7 is an example of an air suction device of the present disclosure.

As shown in FIG. 1 and FIG. 5, the air suction portion 7 includes the air duct 71, fans 73, and a filter 74.

The air duct 71 is a passage through which the air moves from the ink ejection space SP1 to outside of the housing 11.

As shown in FIG. 5, the air duct 71 includes a storage portion 711, air suction ports 712, a first wind passage 713, a second wind passage 714, and an air discharge port 715.

The storage portion 711 stores the fans 73 (see FIG. 6). The storage portion 711 is disposed to face the recording portion 3 across the conveyance belt 51. In other words, the storage portion 711 is provided on the rear side of the sheet support surface F1. As shown in FIG. 6, the storage portion 711 is formed in the shape of a box, wherein a side wall 711A, namely a rear side wall of the storage portion 711, is opened at its center so that the rear side of the storage portion 711 communicates with the first wind passage 713.

The air suction ports 712 are provided in the upper surface of the storage portion 711. As shown in FIG. 4, three air suction ports 712 are aligned along the conveyance direction D4, facing the center of the conveyance belt 51 in the front-rear direction D2. As shown in FIG. 1, the air suction ports 712 are opened toward the recording portion 3, with the conveyance belt 51 present therebetween. The interior space of the storage portion 711 communicates with the ink ejection space SP1 via the air suction ports 712 and the through holes 511 (see FIG. 3) of the conveyance belt 51.

The first wind passage 713 is a passage through which the air moves, and is formed to extend from the side wall 711A of the storage portion 711 rearward. As shown in FIG. 5, the first wind passage 713 includes a tapered portion 713A and an extension portion 713B. As shown in FIG. 6, the tapered portion 713A is formed successively to a rear end part of the storage portion 711, and is formed in a tapered shape where the left and right side walls are tapered rearward. As shown in FIG. 5, the extension portion 713B is formed in the shape of a hollow rectangular prism that extends rearward from a rear end part of the tapered portion 713A (a connection portion connecting the guide members 71A and 71B and the guide member 71C). The extension portion 713B extends up to a wall portion 714A (see FIG. 5) that forms a rear end part of the second wind passage 714.

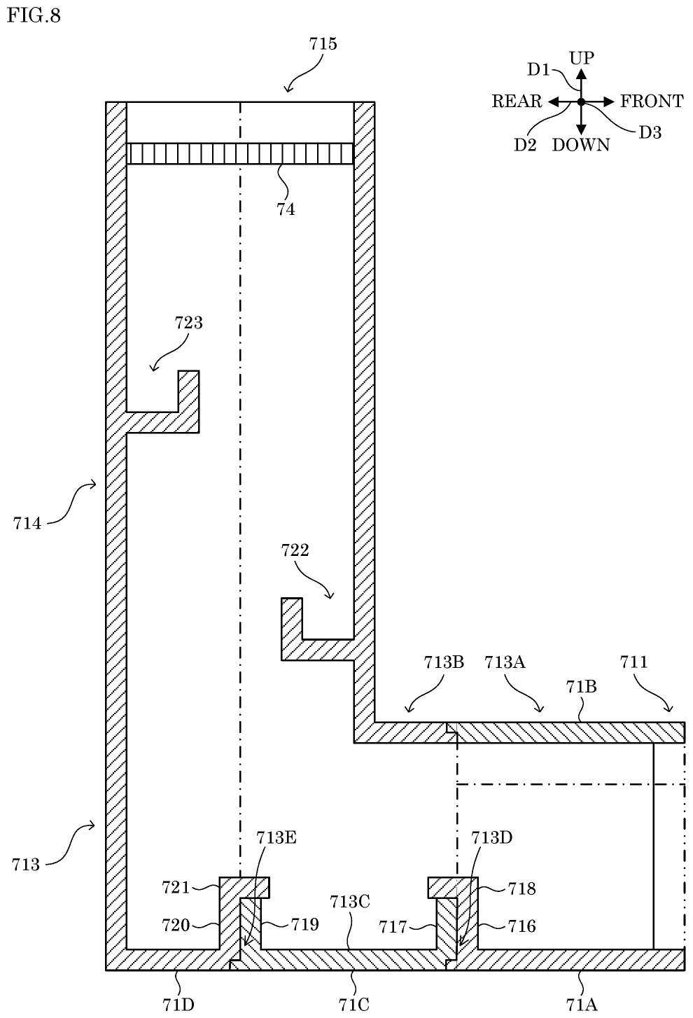

The second wind passage 714 is a passage through which the air moves, and is formed to extend from a bottom surface 713C (see FIG. 8) of the first wind passage 713 upward. As shown in FIG. 5, the second wind passage 714 is formed in the shape of a hollow rectangular prism that extends upward from an extension end of the extension portion 713B. An upper end part of the second wind passage 714 forms a peripheral part of the air discharge port 715. The air discharge port 715 is connected to an opening (not shown) formed in an outer surface of the housing 11. Here, the second wind passage 714 is an example of a wind passage of the present disclosure.

As shown in FIG. 6 and FIG. 7, the air duct 71 includes the guide members 71A, 71B, 71C, and 71D. The guide members 71A, 71B, 71C, and 71D are formed from, for example, resin.

Specifically, as shown in FIG. 6, the storage portion 711 and the tapered portion 713A of the air duct 71 are composed of the guide members 71A and 71B. The guide member 71A forms lower parts of the storage portion 711 and the tapered portion 713A. The guide member 71B forms upper parts of the storage portion 711 and the tapered portion 713A.

In addition, as shown in FIG. 7, the extension portion 713B and the second wind passage 714 of the air duct 71 are composed of the guide members 71C and 71D. The guide member 71C forms front parts of the extension portion 713B and the second wind passage 714. The guide member 71D forms rear parts of the extension portion 713B and the second wind passage 714.

The fans 73 generate air flows that move inside the air duct 71 toward the air discharge port 715. As shown in FIG. 6, the fans 73 are respectively disposed below the air suction ports 712 in the storage portion 711. For example, the fans 73 are sirocco fans that suck the air from the air suction ports 712 side, and blow out the sucked air in a blow-out direction D5 (see FIG. 6) that is directed to the first wind passage 713 side. When the fans 73 are driven, the air in the ink ejection space SP1 is sucked into the air duct 71 via the through holes 511 of the conveyance belt 51 and the air suction ports 712. This allows the sheet supported by the sheet support surface F1 to be attracted to the sheet support surface F1. In addition, the air blown out in the blow-out direction D5 is guided to the air discharge port 715 by the first wind passage 713 and the second wind passage 714.

It is noted that the number and arrangement of the air suction ports 712 provided in the upper surface of the storage portion 711 may be different from those described above. In addition, the number and arrangement of the fans 73 may be different from those described above.

The filter 74 is provided in the vicinity of the air discharge port 715 in the second wind passage 714. The filter 74 is configured to capture ink mist that is contained in the air flows generated by the fans 73.

Meanwhile, in the inkjet recording apparatus 10, the bottom surface 713C of the first wind passage 713 is formed from the guide members 71A, 71C, and 71D (see FIG. 8). As a result, the bottom surface 713C has joints 713D and 713E, wherein the joint 713D is formed between the guide member 71A and the guide member 71C, and the joint 713E is formed between the guide member 71C and the guide member 71D (see FIG. 8). In a case where the bottom surface 713C has the joints 713D and 713E, the ink mist contained in the air flows moving inside the air duct 71 may be accumulated on the bottom surface 713C as ink, and the ink may leak outside the air duct 71 through the joint 713D or the joint 713E.

On the other hand, the inkjet recording apparatus 10 according to the embodiment of the present disclosure prevents leakage of the ink from the bottom surface 713C, as described below.

Specifically, as shown in FIG. 8, the air duct 71 includes a pair of wall portions 716 and 717, a shielding portion 718, a pair of wall portions 719 and 720, a shielding portion 721, and accumulation portions 722 and 723. Here, FIG. 8 is a cross-sectional diagram taken along a VIII-VIII line viewed from a direction indicated by the arrows VIII-VIII of FIG. 4. It is noted that in FIG. 8, connection portions connecting the guide members of the air duct 71 are represented by one-dot chain lines.

The pair of wall portions 716 and 717 are provided on the bottom surface 713C to face each other across the joint 713D. Specifically, as shown in FIG. 8, the wall portion 716 is provided at a rear end of the guide member 71A. In addition, the wall portion 717 is provided at a front end of the guide member 71C. The pair of wall portions 716 and 717 are provided such that a facing surface of one of the pair of wall portions 716 and 717 and a facing surface of the other of the pair of wall portions 716 and 717 that face each other, are in contact with each other. The pair of wall portions 716 and 717 extend to cover the whole region between the left and right side walls of the first wind passage 713. The presence of the pair of wall portions 716 and 717 prevents ink accumulated on the bottom surface 713C from moving into the joint 713D.

The shielding portion 718 is provided in such a way as to protrude from an upper end of the wall portion 716 to the wall portion 717 side to cover an upper end of the other of the wall portion 716 and the wall portion 717. Specifically, as shown in FIG. 8, the shielding portion 718 is formed to protrude rearward of the wall portion 717. In addition, the shielding portion 718 is formed to be in contact with an upper end part of the wall portion 717 so that a gap is not formed therebetween. The presence of the shielding portion 718 prevents ink that has adhered to the upper end part of the wall portion 716 or 717 from entering into between the wall portions 716 and 717.

The pair of wall portions 719 and 720 are provided on the bottom surface 713C to face each other across the joint 713E. Specifically, as shown in FIG. 8, the wall portion 719 is provided at a rear end of the guide member 71C. In addition, the wall portion 720 is provided at a front end of the guide member 71D. The pair of wall portions 719 and 720 are provided such that facing surfaces of the pair of wall portions 719 and 720 facing each other are in contact with each other. The pair of wall portions 719 and 720 extend to cover the whole region between the left and right side walls of the first wind passage 713. The presence of the pair of wall portions 719 and 720 prevents ink accumulated on the bottom surface 713C from moving into the joint 713E.

The shielding portion 721 is provided in such a way as to protrude from an upper end of the wall portion 720 to the wall portion 719 side to cover an upper end of the other of the wall portion 719 and the wall portion 720. Specifically, as shown in FIG. 8, the shielding portion 721 is formed to protrude frontward of the wall portion 719. In addition, the shielding portion 721 is formed to be in contact with an upper end part of the wall portion 719 so that a gap is not formed therebetween. The presence of the shielding portion 721 prevents ink that has adhered to the upper end part of the wall portion 719 or 720 from entering into between the wall portions 719 and 720.

It is noted that the shielding portion 721 may be provided in such a way as to protrude from the upper end part of the wall portion 719 to the wall portion 720 side. In addition, the air duct 71 may not include the shielding portion 718 and the shielding portion 721.

The accumulation portions 722 and 723 are provided on the inner wall surface of the second wind passage 714 so as to receive and accumulate ink that run down the inner wall surface of the second wind passage 714 downward.

Specifically, as shown in FIG. 8, the accumulation portion 722 includes a bottom portion and a wall portion, wherein the bottom portion protrudes rearward from an inner wall surface of a front-side wall of the second wind passage 714, and the wall portion is formed to stand at an extension end of the bottom portion. The accumulation portion 722 extends to cover the whole region between the left and right side walls of the second wind passage 714. The accumulation portion 722 prevents ink that has adhered to the inner wall surface of the front-side wall of the second wind passage 714, from moving downward. As a result, it is possible to reduce the amount of ink accumulated on the bottom surface 713C.

The accumulation portion 723 includes a bottom portion and a wall portion, wherein the bottom portion protrudes frontward from an inner wall surface of a rear-side wall of the second wind passage 714, and the wall portion is formed to stand at an extension end of the bottom portion. The accumulation portion 723 extends to cover the whole region between the left and right side walls of the second wind passage 714. The accumulation portion 723 prevents ink that has adhered to the inner wall surface of the rear-side wall of the second wind passage 714, from moving downward. As a result, it is possible to reduce the amount of ink accumulated on the bottom surface 713C.

It is noted that a plurality of the accumulation portions 722 may be provided on the inner wall surface of the second wind passage 714. In addition, a plurality of the accumulation portions 723 may be provided on the inner wall surface of the second wind passage 714. Furthermore, a plurality of the accumulation portions 722 and a plurality of the accumulation portions 723 may be provided on the inner wall surface of the second wind passage 714. For example, the accumulation portions 722 and the accumulation portions 723 may be arranged alternately along the movement direction of the air flows that move inside the air duct 71. In addition, the air duct 71 may not include the accumulation portion 722 and the accumulation portion 723.

As described above, in the air duct 71 of the inkjet recording apparatus 10, the pair of wall portions 716 and 717 are provided on the bottom surface 713C to face each other across the joint 713D, and the pair of wall portions 719 and 720 are provided on the bottom surface 713C to face each other across the joint 713E. This prevents leakage of the ink from the bottom surface 713C.

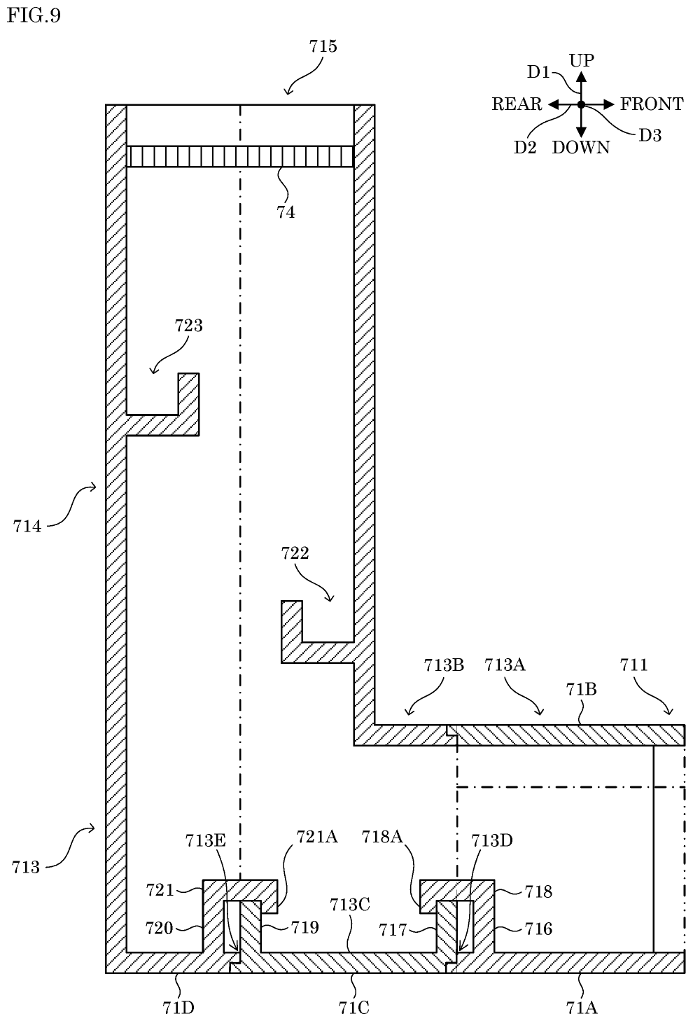

It is noted that as shown in FIG. 9, the pair of wall portions 716 and 717 may be provided such that their facing surfaces facing each other are separated from each other. Similarly, the pair of wall portions 719 and 720 may be provided such that their facing surfaces facing each other are separated from each other.

In addition, as shown in FIG. 9, the shielding portion 718 may include a claw portion 718A that protrudes downward from a protrusion end of the shielding portion 718. In addition, the shielding portion 721 may include a claw portion 721A that protrudes downward from a protrusion end of the shielding portion 721.

In addition, the present disclosure may be applied to an image forming apparatus that forms an image by an electrophotographic method. Specifically, the present disclosure may be applied to an image forming apparatus that includes a humidifying device and an air suction device, wherein the humidifying device is configured to spray mist toward a sheet to which a toner image has been fixed by a fixing device, and the air suction device sucks the air in a space that has been humidified by the humidifying device. In this case, small drops of water contained in the mist are another example of the liquid droplets of the present disclosure.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An air suction device comprising:
an air duct including a plurality of guide members and extending from an ejection space in which liquid droplets are ejected, to an air discharge port; and
a fan configured to generate an air flow that moves inside the air duct toward the air discharge port, wherein
the air duct includes:
a wind passage extending upward from a bottom surface that is formed from the plurality of guide members, the wind passage being configured to guide the air flow; and
a pair of wall portions formed on the bottom surface to face each other across a joint connecting the plurality of guide members.

2. The air suction device according to claim 1, wherein the pair of wall portions are in contact with each other.

3. The air suction device according to claim 1, wherein
one of the pair of wall portions includes a shielding portion that protrudes from an upper end of the one of the pair of wall portions to the other of the pair of wall portions to cover an upper end of the other of the pair of wall portions.

4. The air suction device according to claim 1, wherein
the air duct further includes:
an accumulation portion that is provided to protrude from an inner wall surface forming the wind passage so as to receive and accumulate the liquid droplets that run down the inner wall surface of the wind passage downward.

5. An inkjet recording apparatus comprising:
the air suction device according to claim 1, wherein
the liquid droplets are ink droplets used to record an image on a recording medium.
